(19) United States
(12) Patent Application Publication
(10) Pub. No.: US 2016/0321499 A1
(43) Pub. Date: Nov. 3, 2016

(54) Learn-Sets from Document Images and Stored Values for Extraction Engine Training

(71) Applicant: Lexmark International, Inc., Lexington, KY (US)

(72) Inventors: Ralph Meier, Rastede (DE); Johannes Hausmann, Corcelles (CH); Harry Urbschat, Oldenburg (DE); Thorsten Wanschura, Oldenburg (DE)

(21) Appl. No.: 14/697,692

(22) Filed: Apr. 28, 2015

(51) Int. Cl. G06K 9/00; G06K 9/62; G06N 99/00

(52) U.S. Cl. CPC G06K 9/00469; G06N 99/005; G06K 9/6262; G06K 9/00456

(57) ABSTRACT

Storage volumes with historic values from document processing are used to create learn-sets for extraction engine training. Text and locations of the text in documents are obtained, such as with OCR routines or by retrieval from storage. The values of the storage volumes get matched to the text and the locations of the text are associated back to the values. Both the values and their locations are provided to extraction engine(s) for training. The form of the values and text may or may not match exactly. A degree of fuzziness matching occurs depending upon a type of value in storage. Types can be provided as user input, defined by entry in a database, or determined heuristically through characters found in the values and text. Merging of character fragments defines still other embodiments as does arranging executable code into modules for hardware, such as imaging devices.

### FIELD OF THE EMBODIMENTS

The present disclosure relates to training extraction engines. It relates further to learn-sets for training obtained from document images and historic data related to the documents saved on storage volumes for an enterprise. The techniques are typified for use in training extraction engines for invoice processing or other work flows.

### BACKGROUND

To train extraction engines with documents, text and locations of the text on the documents are obtained. Optical Character Recognition (OCR) routines executed on images of the documents provide this information as do Portable Document Format (PDF) files with text, or by other means, as is known. Enterprises often store these images or hard copy versions of the documents for years for purposes of auditing, financing, taxing, etc. Enterprises also often store values pertaining to the documents. With invoicing documents, enterprises regularly store data such as payee names, due dates, account numbers, amounts paid, addresses, and the like.

The inventors have identified techniques to train extraction engines by exploiting this stored data relating to documents. In combination with hard copies of the document or stored images, techniques ensue that determine localization of the stored values in the documents, but whose values otherwise have no localization information associated therewith. Appreciating that many imaging devices have scanners and resident controllers, the inventors have further identified execution of their techniques as part of executable code for implementation on hardware devices. They have also noted additional benefits and alternatives as seen below.

### SUMMARY

The above and other problems are solved by methods and apparatus for creating learn-sets from document images and stored values for extraction engine training. The techniques are typified for use in training extraction engines for invoice processing by exploiting databases of enterprises having years of data from invoice documents, such as payee names, due dates, account numbers, amounts paid, addresses, and the like.

In a representative embodiment, storage volumes (e.g., databases) with historic values from document processing get converted into learn-sets for extraction engine training. Images of the document get processed to receive text and locations of the text in the document, such as with OCR or stored image data. Data in the storage volumes includes document values comprised of characters and defining value types. They represent items such as dates, monetary amounts, account numbers, words, phrases, and the like. Their form may or may not match exactly to the text of the document from which they were obtained. Through fuzzy matching, the values are associated to the text and their locations to obtain localization information for the values of the database. This is then supplied to an extraction engine for training Implementation as executable code on a controller of an imaging device with a scanner typifies an embodiment. Determining which types of values in the storage volumes get mapped to the text of the document defines another embodiment as does application of differing fuzzy rules depending on the value type. Merging of character fragments defines still another embodiment. Arranging executable code into modules according to function is still yet another feature.

These and other embodiments are set forth in the description below. Their advantages and features will become readily apparent to skilled artisans. The claims set forth particular limitations.

### BRIEF DESCRIPTION OF THE DRAWINGS

FIG. 1 is a diagram of a computing system environment for creating learn-sets from document images and stored values for extraction engine training;

FIG. 2A is a diagram of representative text and locations of text from a document image;

FIG. 2B is a diagram of representative values corresponding to documents saved on a storage volume; and

FIG. 3 is a work-flow for creating learn-sets for extraction engine training.

### DETAILED DESCRIPTION OF THE ILLUSTRATED EMBODIMENTS

In the following detailed description, reference is made to the accompanying drawings where like numerals represent like details. The embodiments are described in sufficient detail to enable those skilled in the art to practice the invention. It is to be understood that other embodiments may be utilized and that changes may be made without departing from the scope of the invention. The following detailed description, therefore, is not to be taken in a limiting sense and the scope of the invention is defined only by the appended claims and their equivalents. In accordance with the features of the invention, methods and apparatus create learn-sets from document images and stored values for extraction engine training.

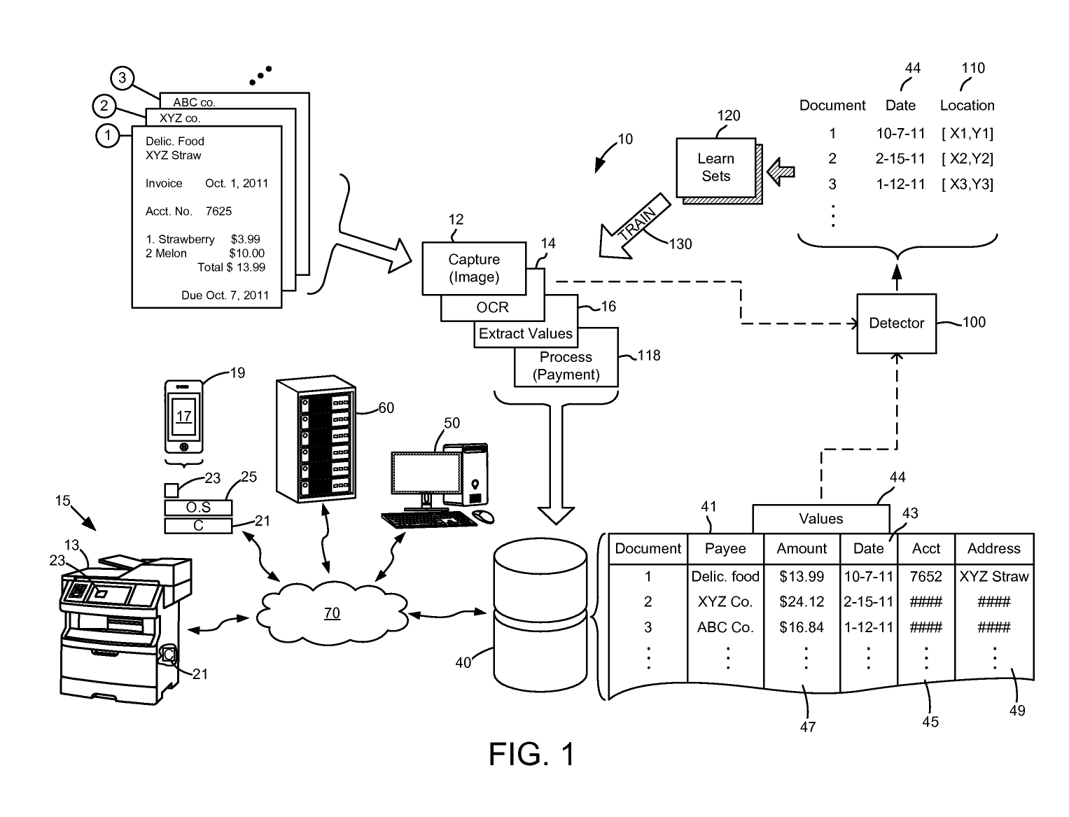

With reference to FIG. 1, a computing system environment 10 includes one or more documents, 1, 2, 3 . . . etc. The documents are any of a variety, but contemplate items such as invoices, tax statements, forms, and the like. Images of the documents get created by capture 12 and such occurs frequently by scanning or by taking a picture/screenshot of the document. Scanning can occur on a scanner 13 of an imaging device 15, while the picture/screenshot 17 occurs with a mobile device 19, such as a tablet or smart phone. The hardware includes one or more controller(s) 21, such as ASIC(s), microprocessor(s), circuit(s), etc. having executable instructions as are known. A user might also invoke a computing application 23 for capturing the image of which is installed and hosted on the controller and/or operating system 25. Alternatively, the images can be obtained from archives, such as might be stored on a storage volume 40. The images can also arrive from an attendant computing system 50 or server 60. A network 70 facilitates the transfer between devices.

Once captured, the image is processed to extract text and locations of text on the document. This occurs with OCR 14, for example, or by a PDF file with text (e.g., PDF/A), or by other. Once known, values get extracted 16 so that work-flow processes 18 can take action on the values, such as paying an invoice, filing a tax return, archiving a document, classifying and routing a document, etc. Enterprises also regularly save on storage volume(s) 40 data extracted from the images of the documents for reasons relating to record retention. With invoices, common values 44 from documents 1, 2, 3, include payee names 41, due dates 43, account numbers 45, amounts paid 47, addresses 49, and the like. With other documents, saved values note words, phrases, monetary amounts, form numbers, receivables, etc. In any form, the values comprise stored characters, such as numbers, letters, symbols, foreign language equivalents, and the like. They may also contain spaces, hyphens, slashes, brackets, or other word processing or other marks.

The values, however, have no localization information associated therewith in the database and so their relative position in the document from which they were obtained remains unknown. This is due to the rationale that enterprises only need the value to execute a payment or perform a process. That the documents are also retained by the enterprise as part of record retention policies, either in hard copy form or as an image stored in the volume(s), a detector 100 takes as input the document along with the values and finds the location 110 of the values in the document. Once the locations are known, learn-sets 120 of documents are created to train 130 the extraction engine. No longer are users required to manually train the extraction engines by individually pointing out values on tens and hundreds of training documents.

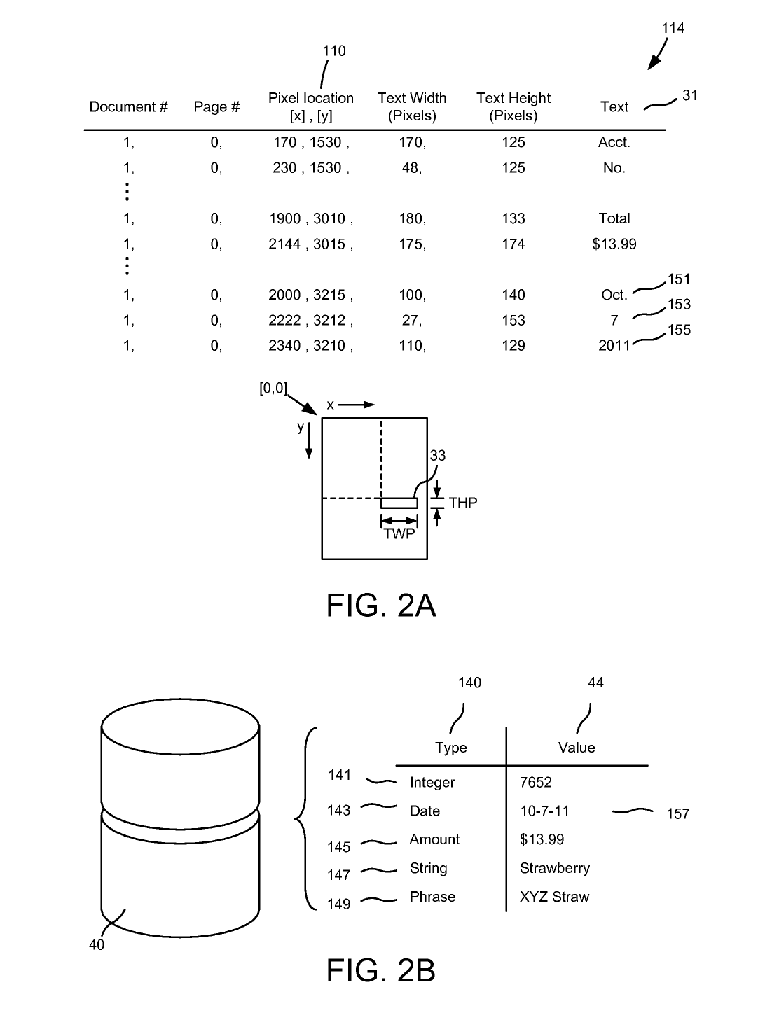

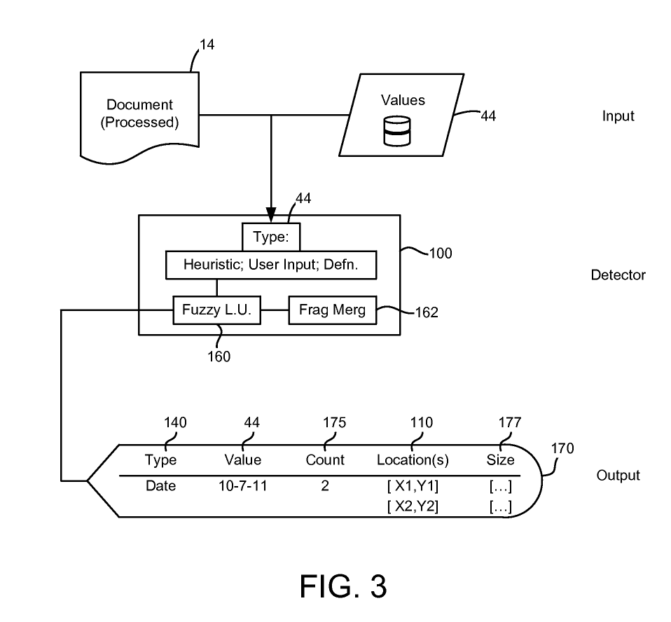

With reference to FIG. 2A, text 31 and locations of text 110 on a document are obtained such as from conducting OCR routines 14. The results include a document number, page number, pixel location 110 [x, y] coordinates (with [0, 0] being the top left corner of a document as shown), text width in pixels (twp), and text height in pixels (thp), (also as shown, thus revealing a box 33 for the text). But compared to the values 44 of the storage volume in FIG. 2B, the text 31 of the document is not always an exact match. As seen on the document, the text October (151), 07 (153), and2011 (155) compares inexactly to the entry 157 of the value “10-07-11” in the database. Thus, a fuzzy comparison 160, detector 100, (FIG. 3) is needed between the values 44 of the storage volume 40 and the text 31 and its locations 110 of the document. Once the values are matched to the text, the locations of the values are also known in the document and can be used to train an extraction engine, for instance. The amount of fuzziness depends on a type 140 of the value in question.

As examples, five basic types of values are presented, but more and different types will be understood by skilled artisans. Herein, the types 140 of values include “integer” 141, “date” 143, “amount” 145, “string” 147 and “phrase” 149. They are representative of entries made by a human when storing data in the storage volume from the documents 1, 2, 3. The format of the entries may be prescribed by the software of the database, the ease of entry by humans, the preferred style of the person entering data, or be set for any other reason. The following challenges are noted for the various forms.

The integer 141 is comprised of a series of sequential numbers in the databases, but will match to text 31 in the document having other characters, such as letters “PO” for purchase order, “No” shorthand for number such as with an account number, and symbols “.” or “:” that might accompany either or both of the letters, such as “P.O.” or “No.” and/or “PO:” and “No:”. Still other symbols of the text 31 might also match to the integers 141 of the database, such as those that delineate purchase orders and account numbers, such as matching value “7652” to text “P0:76-52” or “No.: 76/52.” Integers 141 will not match to text of the form “76,52” or “76.52” to avoid confusion with commonly used forms of text for noting “amounts” 145 of money.

For dates 143, the challenge is to map any date written on a document to a date usually stored in a canonical format in a database. For example the database value “20140311” stored in the format YYYYMMDD (where the letters are to be understood as Y=Year, M=Month, D=Day—representing digit), shall be used to localize text like “Fri, 11th March 2014” or “14-11-03” or “11-03-14”. This pertains to the need to represent different data styles for different countries, different wording for different languages and any combination thereof. Well known forms of dates also include symbols such as “/” and “.” between days, months and years. Days and months are also frequently inverted relative to one another depending upon country whether or not written with numbers or words, compare e.g., 9/10/15 vs. 10/9/15 or September 10, 2015, vs. 10 September 2015. Years are regularly inverted with days/months as either YYYYMMDD or MMDDYYYY. Days and months sometimes also include zero digits preceding the actual digit of the day or month, e.g., “09.” Years are often given as two digits (YY) instead of four (YYYY), e.g., “15” vs. “2015.” The fuzzy lookup for dates contemplates all these and still other scenarios. The fuzziness of the amount 145 shall be configured to optimally find values like “$1.234,21” or “USD1234.21” or written words, e.g., “one thousand two hundred thirty four dollars and 21 cents” for a given database value of “1234.21”. Dollar signs ($) are also noted as being replaceable with other symbols noting other currency values, such as the Euro ( [symbol] ), Lira (£), etc. Letter characters are also common ways of representing amount values, such USD (United States Dollar), INR (Indian Rupee), DM (Deutsche Mark), etc. There may be also double instances of currency symbols, such as $$ when preceding numbers of amounts. Skilled artisans will understand even further fuzziness rules to apply to matching amounts 143 to text 31 in a document.

The strings 147 are denoted to find any “words” in the text of a document. Strings contemplate the lowest level of fuzziness which can abstract phonetically similar characters across multi-languages, normalize the case (upper or lower case), and take typical OCR misrecognition confusion probabilities into account. Examples of OCR misrecognition include mistaking closed brackets “]” for the numeral “1”, swapping “h” for “b” or “c” for “e”, and vice versa. Application of grammar rules in various languages is also contemplated. For example, English words beginning with the letter “q” are mostly frequently followed by the letter “u.” Similarly, in German, the letter “β” orthographically only exists in lower case as it never begins a word. Words can also exist vertically in a document, from left to right, and can define acronyms, such as stock symbols. Of course, there are many other examples of finding and matching strings in a database to words in a document. Phrases 149, on the other hand, are defined as more than one string. Often times, phrases consist of strings separated by a space, e.g.,., “payment terms” or “strawberry road.” Other symbols or integers may be noted too, e.g., “Delic. Food” or “net 14 days.”

Since text 31 generated by OCR often misidentifies a terminal boundary of dates, strings, phrases, etc., the detector 100 further includes a module 162, FIG. 3, for merging fragments of characters, if needed. The goal of merging is to join textual fragments that are spread in two dimensions across the textual representation of a document so long as the joinder results in a meaningful merger given the text and the respective fuzziness of the type of the value. As an example, given the line “252” “Friday” “, 12” “t8” “Ma” “y” “2011” the merging module 162 collects the fragments for a valid date and glues them together to form a meaningful date. In this example the “ ” (double quotes) denote word boundaries returned by OCR. The “t8” is likely to be misrecognition of a superscript “th” and might be converted to a “th” or ignored since it is not needed for a valid date representation. The “Ma” and “y” are merged together since they define a name of a month. The “252” is ignored since it does not define a date. A well-formed string returned from the merger, therefore, would be of the form “Friday, 12th May 2011”. Of course, other examples are readily understood.

The result of the detector 100 is a list 170 of matched text 31 to values 44 and the localization 110 of the values. As more than one match can occur, the list also notes a count 175 of the multiple location(s) where matching occurred. A size is also optionally provided in the list.

The foregoing illustrates various aspects of the invention. It is not intended to be exhaustive. Rather, it is chosen to provide the best illustration of the principles of the invention and its practical application to enable one of ordinary skill in the art to utilize the invention. All modifications and variations are contemplated within the scope of the invention as determined by the appended claims. Relatively apparent modifications include combining one or more features of various embodiments with features of other embodiments. All quality assessments made herein need not be executed in total and can be done individually or in combination with one or more of the others.

1. A method of creating a learn-set for extraction engine training, comprising:
obtaining an image of a document;
receiving text and locations of the text from the image;
retrieving from an accessible storage volume at least one value of the document; and
associating the at least one value to the text to obtain a location of the at least one value of the document.

2. The method of claim 1, wherein the obtaining said image further includes scanning the document with an imaging device.

3. The method of claim 1, wherein the obtaining said image further includes retrieving the image from said accessible storage volume.

4. The method of claim 1, wherein the receiving text and locations of the text further includes executing OCR on the image.

5. The method of claim 1, further including obtaining multiple locations of the at least one value in the document.

6. The method of claim 1, wherein the associating the at least one value to the text does not result in an exact match of characters between the at least one value and the text.

7. The method of claim 6, further including fuzzy matching the at least one value to the text.

8. The method of claim 1, wherein the associating the at least one value to the text further includes merging fragments of characters.

9. The method of claim 1, further including determining a type of the at least one value.

10. The method of claim 9, wherein the determining the type further includes examining an arrangement of the characters of the at least one value as stored in the accessible storage volume, receiving a type input from a user, or determining the type heuristically from the characters of the text and the at least one value.

11. The method of claim 1, further including supplying to an extraction engine the at least one value and the location of the least one value.

12. A method of creating a learn-set for extraction engine training, comprising:
obtaining an image of a document;
receiving text and locations of the text from the image;
accessing a storage volume having multiple values stored from the document, each value comprising characters and defining a type of the value and having no localization information associated therewith; and
associating the values to the text to obtain locations of the values in the document.

13. The method of claim 12, wherein the obtaining said image further includes scanning the document with an imaging device or retrieving the image from said storage volume.

14. The method of claim 12, wherein the associating the values to the text further includes fuzzy matching the values to the text.

15. The method of claim 12, wherein the associating the values to the text further includes merging fragments of the characters.

16. The method of claim 12, further including determining a type of the values before the associating to the text.

17. The method of claim 16, wherein the determining the type further includes examining an arrangement of the characters of the values stored in the storage volume, receiving a type input from a user, or determining the type heuristically from the characters of the text and the values.

18. An imaging device, comprising:
a scanner;
a connector for access to a network; and
a controller, the controller having executable instructions configured to
receive an image of a document scanned by the scanner,
perform OCR on the image to ascertain text and locations of the text from the image;
access multiple values pertaining to the document from a storage volume by way of the network, each value comprising characters and defining a value type and having no localization information associated therewith; and
associate the values to the text from the OCR to obtain locations of the values in the document.

19. The imaging device of claim 18, wherein the controller is further configured to fuzzy match the values to the text.

20. The imaging device of claim 18, wherein the controller is further configured to merge fragments of the characters.
